(19) United States
(12) Patent Application Publication
(10) Pub. No.: US 2018/0144352 A1
(43) Pub. Date: May 24, 2018

(54) PREDICTING STUDENT RETENTION USING SMARTCARD TRANSACTIONS

(71) Applicant: Arizona Board of Regents on Behalf of the University of Arizona, Tucson, AZ (US)

(72) Inventors: SUDHA RAM, Tucson, AZ (US); Yun WANG, Tucson, AZ (US); Sabah Ahmed CURRIM, Tucson, AZ (US); Faiz Ahmed CURRIM, Tucson, AZ (US)

(21) Appl. No.: 15/453,668

(22) Filed: Mar. 8, 2017

Related U.S. Application Data
(60) Provisional application No. 62/305,374, filed on Mar. 8, 2016.

(51) Int. Cl. G06Q 30/02; G06Q 50/20; G06Q 20/10

(52) U.S. Cl. CPC G06Q 30/0202; G06F 17/12; G06Q 20/10; G06Q 50/20

(57) ABSTRACT

Systems and methods for analyzing student retention rates are disclosed. The systems and methods disclosed construct networks of students based on data associated with financial transactions conducted by those students. The systems and methods analyze the networks of students to calculate network features associated with the networks and utilize those network features to forecast student retention. The network features analyzed include node appearance metrics, degree metrics, and edge metrics. The systems and methods may also utilize campus integration metrics calculated from data associated with financial transactions conducted by students to forecast student retention.

### CROSS REFERENCE TO RELATED APPLICATION

This application claims benefit of U.S. Provisional Application No. 62/305,374, filed Mar. 8, 2016, which is hereby incorporated herein by reference in their entirety.

### FIELD OF THE INVENTION

The present invention relates to systems and methods that utilize data associated with financial transactions to construct networks and calculate metrics that can be used to forecast student retention.

### BACKGROUND OF THE INVENTION

Over the years, student retention has been one of the most challenging problems that higher education faces. Various survey-driven studies have been done to develop theoretical models for explaining the factors that influence student retention. Despite these efforts devoted to student retention, student persistence and graduation rates have shown disappointingly little change over decades (Nandeshwar et al. 2011). A significant proportion of students drop out of college in the first year itself, which gives universities little time to intervene (Thammasiri et al. 2014).

Therefore, a key to increasing student retention rates is to identify freshmen at-risk of dropping out early. However, survey-driven methods are not the optimal solution for real-time intervention through early identification because the process of conducting a large-scale survey is time-consuming and expensive. This is in addition to the problem of low participation rates and self-bias in student surveys (Sarker et al. 2014). As an alternative, researchers have explored retention-related variables from institutional student datasets (ISD) which typically contain information such as demographics, educational background, economic status and academic progress. Among these research efforts, data mining techniques that formulate identifying students at-risk as a binary-classification problem are popular. However, only a few existing data mining approaches address the class imbalance issue where drop-out students have a much smaller sample size than retained students (Thammasiri et al. 2014).

Therefore, these attempts leave significant areas for improvement on the issue of class imbalance learning. Another drawback of existing data mining approaches is that nearly all these models use first semester Grade Point Average (GPA) and report it as the most influential predictor. Thus, these models may not be helpful if the university wants to identify at-risk students before the first semester ends. These models do not consider social factors (e.g., social or campus integration) which are unavailable in traditional ISDs and traditionally require a survey-driven methodology.

In order to address these issues, we improved existing data mining approaches from two perspectives. From a feature extraction perspective, we augment standard ISDs with information that can capture student integration into campus life (identified as a contributory factor in prior socio-psychological studies). This augmentation is extremely important for proactive attrition prediction when students' first semester GPA is unknown. More specifically, we include two new forms of insight from smartcard transaction data: 1) implicit social networks derived from transactions. 2) Sequences of locations visited by each student on a daily basis. The former enables us to infer students' social integration from network measurements. The latter can help measure a student's level of integration (i.e., based on regular use of campus facilities). From a model-refinement perspective, we enhance class imbalance learning in both the sampling and learning phase. In the sampling phase, we propose a cluster-based under-sampling method to generate multiple balanced samples without losing the distribution pattern of the majority class. In the learning phase, we apply ensemble methods on the multiple balanced training samples.

The rest of this disclosure is organized as follows: Section “Related Work” provides a condensed review of student retention and data-balancing. Section “Data and Feature Extraction” describes the student dataset and our methods for feature extension. Section “Class Imbalance Learning” presents our model for class imbalance learning in this research. Section “Experimental Evaluation” discusses the experimental setup and presents comparison results. The last section concludes the disclosure with future directions.

Student Retention

Based on the methods of data collection, previous studies on student retention can be categorized into two types: survey-driven research and data-driven research. Fundamental models of survey-driven research include Tinto's student integration model(Tinto 1975), Astin's theory of involvement(Astin 1999) and Bean's student attrition model (Bean 1982). The three models all agree that students' social integration is among the most important indicators. Other significant factors include: students' past academic progress (e.g., high school GPA and standardized test scores), financial factors such as loans, grants and scholarships and parents' education levels (Reason 2009). Nevertheless, administrations face challenges in applying survey findings in practice for several reasons: 1) low response rate of at-risk students due to their lower levels of institutional integration; 2) poor cost-effectiveness because the number of at-risk students is small compared to overall student population; 3) self-reporting bias, i.e., students may choose not to reveal accurate details of their social network and interactions.

On the other hand, rapidly increasing data volume in university's data warehouse warrants data mining approaches. Typical features used for training are: demographics, high school GPA, standardized test scores, college GPA and financial indicators; first-semester GPA is reported to be most powerful indicator in several studies (Delen 2011; Sarker et al. 2014; Thammasiri et al. 2014). Waiting for first-semester GPA to train the classifier means the university has already lost some students. An issue in existing data-driven approaches is that standard ISDs do not contain variables identified by social science theories such as social integration and peer relationships. We argue that it is possible to analyze existing institutional resources to obtain comparable information, leading to gains in timeliness of information (and interventions), and cost savings.

Class Imbalance Learning

The class imbalance problem refers to the situation where members of one class considerably outnumber the other class in a dataset. For example, with a 90% retention rate, only 10% of the observations belong to the drop-out (prediction) class. There are two strategies for class imbalance learning: modifying a classifier or balancing data with different sampling methods. One of the most widely used classifier modifications is cost-sensitive learning which assigns costs to misclassified examples. However, misclassification costs are usually unknown and lead to over-fitting (He and Garcia 2009).

Under-sampling and over-sampling are the two popular data balancing strategies. Without any heuristics, under-sampling randomly generates a subset of the majority class which might lead to the loss of information. Similarly, uninformed over-sampling randomly picks minority samples to replicate, which will cause over-fitting. One popular informed over-sampling method is the synthetic minority oversampling technique (SMOTE) which creates artificial data based on the similarities between existing minority examples. However, SMOTE blindly generates synthetic minority class samples without considering majority class samples, so it may cause over-generalization. Various adaptive SMOTEs such as, Borderline-SMOTE and Adaptive Synthetic Sampling have been proposed to overcome this problem (He and Garcia 2009). A state-of-the-art study on imbalanced classification proposed a novel and practical variation of under-sampling that randomly splits the majority class into even-sized pieces (Xu and Zhou 2014). However, random splitting cannot guarantee that the majority samples in each subset maintain the same distribution as before the split. In other words, the distribution of the majority class is altered in each subset. We address these challenges in our research.

Predicting Location-Based Sequential Purchasing Events by Using Spatial, Temporal, and Social Patterns

Widespread adoption of location-enabled systems that can track human activities has enabled the study of human mobility patterns. Data from check-in records in location-based social networks (LBSNs) and from mobile device trajectories, for example, are being mined for interesting insight. In addition, fundamental findings in the deep-rooted regularity of human mobility are providing solid scientific support for the development of predictive models. The ability to predict a user's location opens the door to the development of anticipatory systems such as location-aware advertising, autonomous traffic control, and proactive personal assistants. Traditional predictive models of human mobility have been based primarily on spatial sequence analysis that discovers sequence dependencies or frequent patterns. However, researchers haven't investigated the activity that occurs in each location, which makes it difficult to predict the outcome precisely. Moreover, the generative process of the sequential data is seldom utilized in the model, and recent efforts to mine temporal patterns from sequential events reveal that data sparsity is a major challenge. Researchers also report that individuals' mobile activity can be affected by their friends in a social network.

### SUMMARY OF THE INVENTION

In this disclosure, we focus on sequential data obtained from purchasing events. Knowing spending tendencies is clearly beneficial for improving recommendation systems and services, so we propose a probabilistic predictive model that incorporates spatial, temporal, and social interaction features extracted from purchasing events. For spatial data modeling, we extract generative patterns from purchases, helping us model spatial sequences by using an innovative smoothing technique adapted from training N-gram models. To our knowledge, this is the first time such a language model is being adapted for location prediction. For temporal data modeling, to address the problem of sparsity, we cluster locations into areas by comparing both geographical and social similarities among them and then extracting temporally triggered mobility patterns from the grouped areas. Explicit social relationships aren't readily available in our dataset, making it difficult to explore patterns of socially triggered activities, so we define a strategy for generating an implicit social network. Using eigenvector centrality, we're able to identify influences among connected customers in the network. The proposed probabilistic model is a combination of three components. We use a spatial prediction component as the base model, combine it with a temporal component for regulating the model, and finally add social influence as a boosting component for the prediction.

### BRIEF DESCRIPTION OF THE FIGURES

A more complete appreciation of the invention and many of the attendant advantages thereof will be readily obtained as the same becomes better understood by reference to the following detailed description when considered in connection with the accompanying drawings, wherein:

FIGS. 1A and 1B show exemplary calculations for each figure, as explained below:

FIG. 1A shows exemplary estimate the value of π by examining drop rate of edges in the graph; and

FIG. 1B shows exemplary validation of the relationship in the network using Common Location Ratio;

FIG. 2 shows an exemplary repeated pattern of location sequences;

FIGS. 3A-3C show exemplary calculations for each figure, as explained below:

FIG. 3A shows exemplary data characteristics of purchasing events following power-law distribution;

FIG. 3B shows exemplary discrete distribution of visiting time; and

FIG. 3C shows exemplary cumulative frequency of common locations among customers inside and outside the implicit social network;

FIG. 4 shows an exemplary probabilistic suffix tree (PST) for sequence l₀l₁l₁l₀ on S={l₀, l₁} where dashed edges are possible expansions for unseen sequences;

FIG. 5 shows exemplary pseudo-code for updating a suffix tree, where the algorithm can be used whenever a new daily sequence is observed;

FIGS. 6A-6C show exemplary calculations for each figure, as explained below:

FIG. 6A shows an exemplary calculation of the spatial model of the present invention compared against baseline Markov models;

FIG. 6B shows a Gaussian Mixture Model with a Dirichlet process prior (DPGMM) and GMM for area and location prediction, respectively; and

FIG. 6C shows overall performance after combining temporal and social features with the spatial model. ST refers to the model based on spatial and temporal features, and STS refers to the ST model incorporating implicit social relationships; and

FIGS. 7A and 7B show an exemplary comparison of proposed STS with M5 Tree.

FIG. 7A shows the average percentile rank (APR) comparison over nine time chunks and

FIG. 7B shows the accuracy comparison on the candidate set size from 1 to 10.

### DETAILED DESCRIPTION OF THE INVENTION

Data and Feature Extraction

In order to improve prediction performance for first-semester retention prediction, we extend the standard ISD features with students' social and campus integration learned from smartcard transactions. In this section, we describe the dataset for our study and introduce two novel feature extraction methods for social and campus integration respectively.

The data used for this study are collected from a large university. We start with an anonymized subset of about 21,300 enrolled freshmen between years 2012 and 2014. This dataset contains variables such as demographics, scholastic context, financial status and family background. Data preprocessing and cleaning were performed to remove outliers, missing values and anomalies. We were left with 18,375 freshman data points, of which 1,242 (6.76%) dropped-out after their first semester in college and 3,850 (20.95%) dropped-out at the end of the first year. For the same group of freshmen, we also used a university smartcard transaction dataset containing approximately 5.3 million transactions made by freshmen during their first academic year. Each transaction has an anonymized student ID, a location indicator and a timestamp. The transaction data reflect students' daily activities on campus, providing a good supplement to ISD which is mostly static information (updated every semester).

Infer Social Integration from Implicit Networks

Let U={u1,u2, . . . ,um} be the set of freshmen; a paired presence of ui,uj∈U is: two students ui,uj who made transactions at the same location within a time interval τ. Here we applied a heuristic that the more paired presences ui and uj have, the more likely that they will have a peer relationship. Also considering that peer relationships might be time varying, we segment the data into bi-weekly periods. For one semester, we have roughly 8 segments. For each of the segments, we infer students' relationship by examining their paired presence. Formally, let the directed networks be denoted as Dp(Up,Ep) for p=1 to 8 where Up⊂U and Ep is the set of edges in Dp. For a pair of students ui,uj∈U if they have at least π (count) paired presences during time period p, then we connect ui,uj and add edges ei→j ej→i to Ep, where ei→j is the directed edge from ui to uj. We use a normalized weight to measure the strength of peer relationships. The weight of edge ei→j is defined as: wi→j=Cijp ΣCihph∈Niph where Nipis the set of neighbors of ui in Dp and Cijp is the number of times ui,uj made transactions together during time period p. Note that this latent relationship is asymmetric. For instance, suppose Bob has only one friend, Alice, on campus (i.e., Alice is the only student connected with Bob in a network), but Alice may have other friends (i.e., edges to other students in the network).

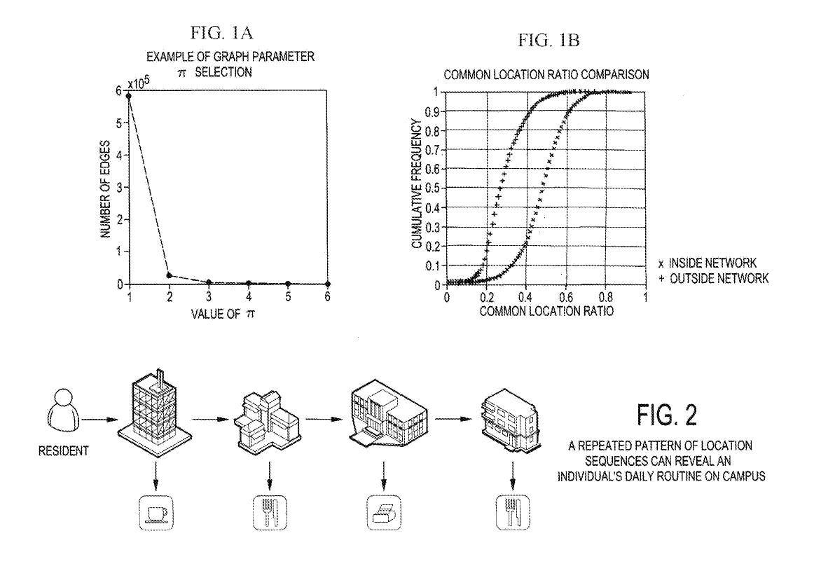

Parameters τ and π need to set to a ‘proper’ value so as to reduce the randomness bias, because a paired presence can be a coincidence. In this study τ is set as 1 minute which was the most restrictive value with the transaction granularity. We gradually increase the value of π until the drop rate of edges become stable. For example, in FIG. 1A we observe a 96% drop rate when π is increased from 1 to 2, a 43% drop rate when π is increased from 3 to 4 and 30% drop rate for 4 to 5. For the purpose of balancing bias and reducing network complexity, we set π to 3. FIG. 1B validates our heuristic of paired presences by comparing common location ratio (CLS) among students. If Li and Lj are the sets of locations visited by ui and uj, then CLS is calculated as CLS=|Li∩Lj∥Li∪Lj|. From FIG. 1(b) we observe that students connected in the network are more likely to visit the same locations.

After network generation, we define three groups of network metrics to infer students' social integration. The first group is about node (student) appearance. The heuristic for this feature group is as follows: a socially active student should frequently and consistently appear in networks. We use the following two metrics: 1) the number of appearance periods of a node (NAP); 2) the longest consecutive appearance period of a node (LCAP). We use NAP to capture the frequency and LCAP to measure the consistency of social activity. Consider a 10 week period (5 networks), if a student appeared in the 1st, 3rd, 4th and 5th network, then her NAP is 4 and LCAP is 3.

The second group, degree metrics group applies the following heuristic: a student's social circle can experience three trends, i.e., stable, growing or shrinking. Among the three, a shrinking social circle may indicate students becoming less sociable. We then define three degree metrics to capture the trends: (1) average degree (AD) in all networks; (2) standard deviation of degree distribution (SDD); (3) the ratio of average degree (RAD) between four networks (corresponding to the first half of the semester) and the second four networks. Here AD reflects the average size of a student's social circle, SDD measures its stability and finally RAD can capture if the social circle is shrinking.

The last edge group is based on the heuristic that sociable students should have strong, stable and symmetric peer relationships. A higher weight of wi→j indicates that uj is an important person ui's social circle. In particular, a maximum weight of 1 means entity ui only makes transactions with uj. Accordingly, we define an edge ei→j in network Dk as strong if (1) wi→j is larger than 0.3; (2) ui and uj have more than 5 paired presences during period k. The parameters are heuristically determined, where 0.3 is the average weight, 5 paired presences in two weeks requires an interaction roughly once every two weekdays. Lastly, we define a peer relationship ei→j as loyal if among all networks, ui and uj are consistently connected. The three edge related metrics are: (1) proportion of strong outgoing edges (PSOE); (2) the probability both in-coming and out-going edges are strong (PSIE); (3) the proportion of ‘loyal’ relationships (PLE) in one's social circle.

Inferring Campus Integration from Sequences of Activities

Campus integration, i.e., how well students integrate into campus life, is another important predictor of student retention. Better integration can lead to a higher chance of retention. Similar to social integration, this kind of information is usually unavailable. However, smartcard transactions can provide some of this information. The students' (processed) transaction history can be used to infer their campus integration (i.e., their choice to use campus services with regularity). Given a student, we can extract transaction locations, segment them by date and order them chronologically in each segment. A daily segment containing a sequence of locations a student visited on a particular day might reveal her campus life routine. For example, in FIG. 2, a student attends a morning class on a weekday and she buys a cup of coffee after the class. At noon, the student goes to the food court for lunch. In the evening, she studies in the library and uses the printer there. Thereafter she goes back to the dorm and buys a snack from a vending machine. Let us further assume this is a regular routine for this student on that weekday, then we should be able to obtain a frequent sequence of locations ordered as ‘coffee shop, restaurant, library printer, dorm vending machine’ from her historical records.

Based on to this assumption, we define our heuristic to infer students' campus integration: students with high level of campus integration are more likely to reveal a frequent pattern from their daily activities. Moreover, campus activities like classes and community activities are scheduled on a weekday basis. If a student is actively engaged on campus (e.g., regularly taking classes), their sequence of visited locations should have more overlap on the same weekdays. Or from the opposite perspective, suppose we have a student who stops attending class in the middle of a semester. This interruption can be captured by discovering a loss of pattern. We implemented this heuristic using the Ratcliff-Obershelp string comparison algorithm (Ratcliff and Metzener 1988). The similarity is measured as the ratio of matching characters to the total number of characters of the two sequences. For every student, we compare his/her weekday similarity from Monday to Friday. Let us further assume we are comparing a total of n weeks, then we formally define the weekday activity similarity (WAC) score as:

$$WAC ( {u}_{i} ) = \frac{1}{5} {\sum }_{k = 1}^{5} \frac{{\sum }_{j = 1}^{n - 1} sim ( {S}_{ik}^{j} , {S}_{ik}^{j + 1} )}{n - 1}$$

where Sᵢₖ^{j} the sequence of visited locations of weekday k in week j of student ui and Monday to Friday is represented using 1 to 5. In this study, we use WAC to infer students' campus integration level.

Class Imbalance Learning

In this section, we introduce our class imbalance learning algorithm. The proposed algorithm has two phases. In the data resampling phase, we used a cluster-based under-sampling strategy to obtain balanced subsets without losing distribution patterns of the majority class. Then in the learning phase, we applied an ensemble method to have an enhanced learning effort.

Cluster-Based Under-Sampling

Compared with over-sampling or its variants, under-sampling will not add artificial data into the dataset, so the distribution of the entire dataset holds. Also, instead of having just one balanced dataset, under-sampling can generate multiple balanced datasets, which makes it possible to adopt enhanced learning such as ensemble methods. However, using uninformed under-sampling, the sampled majority class subset is unlikely to have the same distribution pattern as the main dataset. To overcome this problem, we use clustering-based under-sampling so the sampled subset has a similar distribution. Assume we have k subclasses in the majority class, when we generate a subset we ensure it contains samples from all the k subclasses, where the size in the subset is proportional to the size in the complete set. By doing so, we can obtain a subset that is closer to the complete set in terms of data distribution. In this study, we adopt X-means algorithm (Dan and Andrew 2000), an extension of K-means which can search for the best number of clusters.

Let k be the number of subclasses identified in the majority class, Nma be the size of the majority class and Nmi be the size of the minority class. The number of majority-class samples in each subclass k is Nₘₐⁱ for 1≤i≤k. Then the number of majority sample members selected from the ith subclass is:

$${N}_{S}^{i} = \frac{{N}_{m i}}{{N}_{ma}} {N}_{ma}^{i} .$$

To create a piece of training set, we first randomly select Nsi from ith subclass with replacement. Then combine the k sampled majority sets together along with the complete minority set to construct a new balanced dataset. This way, we can generate multiple balanced datasets which can be used to train the ensemble classifier.

Ensemble Method

In the supervised learning phase, we use the balanced data obtained from resampling to train the base classifiers. After training, each classifier will output a class label for a test sample. An ensemble method is needed to combine the results. In this study, we consider two ensemble methods: Distance-based Majority Voting (DMV) and Stacking. To compare the two methods, we first make following assumptions. Suppose we built C binary classifiers and Di for 1≤i≤C is the balanced dataset for ith classifier. Let lp,ln be the two possible labels, then fi(x) is the label that ith classifier predicts x belongs to.

DMV is an extension of majority voting in which results from base-classifiers are dynamically weighted. Given a test sample x, its weight on ith classifier is the inverse of average distance between x and all training samples in Di, which can be formally defined as:

$$Wi ( x ) = \frac{\vert {D}_{i} \vert}{{\sum }_{y ∈ {D}_{i}} DIST ( x , y ) + 1}$$

where DIST(x,y) be the Euclidean Distance in this study. The heuristic for this weighting strategy is as follows: if a test sample is closer to a training set then the weight of this set should be higher for the test sample. DMV simply selects the label that has the most weighted votes, so the label of x is where

$$Arg {max}_{l ∈ \{ {l}_{p} , {I}_{n} \}} {\sum }_{i = 1}^{C} {W}_{i} ( x ) Vote ( l , {f}_{i} ( x ) )$$

where Vote(l,fi(x))=1 if l=fi(x).

On the other hand, Stacking is a meta-model derived from a meta-dataset (Dz̆eroski and Ženko 2004). In this study, we resampled a new balanced data set D′ and used it to train a Support Vector Machine (SVM) as the meta-model. In particular, for every x′∈ D′, we create a new training instance (f1(x′), f2(x′), . . . ,fn(x′),lx′) where lx′ is the actual label of x′. Essentially, the inputs of the meta-model are the outputs from base classifiers. By combining heterogeneous classifiers, Stacking usually can obtain better performance than any single base classifier.

Experimental Evaluation

In this section, we evaluate our proposed model from the following aspects: 1) the ability of early prediction (before the end of first semester); 2) the necessity for a data balancing technique; 3) performance comparison of different class imbalance learning techniques.

We use Random Forest (RF) as the baseline model trained with only ISD features. We name the baseline model with new extended features as “RF_NEW”. For the ensemble learning, we select SVM, C4.5, Naïve Bayesian (NB) and Radial Basis Function Neural Network (RBFNN) as the base classifiers for the ensemble learning. “CU_DMV” refers the model using Clustering-Based Under-sampling and Distance based Majority Voting. Similarly, “CU_Stacking” refers to the model using Clustering-Based Under-sampling and stacking ensemble. In this experiment, we also included the SMOTE_SVM algorithm which has been reported to have best performance in past work (Thammasiri et al. 2014). For the three class imbalance learning models, we use all the features (ISD+Social/Campus integration) for training. For every model, we perform 10-fold cross validation to measure metrics including accuracy, area under the Receiver Operating Characteristic curve (AUROC), precision, recall and F2-score. Considering the goal of prediction is to find students at-risk of attrition, we define drop-outs as the positive class (+), continuing students as negative class (−). Not identifying a drop-out always costs more than providing unnecessary intervention to a student who persists, so we give a higher weight to metrics like recall and F2-score. For our work we define proactive prediction as being performed 4 weeks before the end of the first semester.

TABLE 1
Results of Best Configuration based on F2-score

| | | | Precision | | Recall | | F₂-score | |
|---|---|---|---|---|---|---|---|---|
| Model | Accuracy | AUROC | + | − | + | − | + | − |
| RF | 0.954 | 0.57 | 0.046 | 0.984 | 0.088 | 0.969 | 0.074 | 0.972 |
| RF_NEW | 0.932 | 0.712 | 0.489 | 0.940 | 0.120 | 0.991 | 0.141 | 0.980 |
| SMOTE_SVM | 0.753 | 0.752 | 0.180 | 0.982 | 0.801 | 0.749 | 0.475 | 0.786 |
| CU_DMV | 0.778 | 0.817 | 0.184 | 0.986 | 0.794 | 0.777 | 0.477 | 0.811 |
| CU_STACKING | 0.784 | 0.826 | 0.201 | 0.983 | 0.813 | 0.782 | 0.512 | 0.812 |

According to Table 1, the baseline model ‘RF’ has a very low sensitivity to the minority class. Comparing ‘RF’ with ‘RF_NEW’, we discovered that using the extended samples to train the baseline model increases the positive class recall from 8.8% to 12% and precision from 4.6% to 48.9%. Solely using new features can improve the model performance but not enough. Among the class imbalance learning algorithms, ‘CU_Stacking’ has the highest F2-score and recall rate for the drop-out class. Therefore, for retention prediction, ‘CU_Stacking’ is identified as having the best performance. Using any of the three balancing techniques greatly increases the model sensitivity; however, all the models have a relative low “+” class accuracy which is a tradeoff with maintaining a high recall rate.

Problem Notation and Data Reconstruction

The dataset in this study comes from a smartcard transaction database of a large, higher education organization that grants undergraduate and graduate degrees. Each record represents a purchasing event containing key information: anonymized customer ID, location name, location address that can be used to infer geographical information, and a timestamp accurate to the minute. Let U={u1, u2, . . . ui . . . } be the set of customers and S={l1, l2, . . . , lj . . . } be the set of unique locations; the set of purchasing events are then denoted as E={<ui, vj, tk>| where ui ∈U, vj ∈ S and tk is a timestamp}. From the event records, we can reconstruct three kinds of new data that represent spatial sequence of locations, temporal preference distribution, and an implicit social network.

Spatial Sequence of Locations

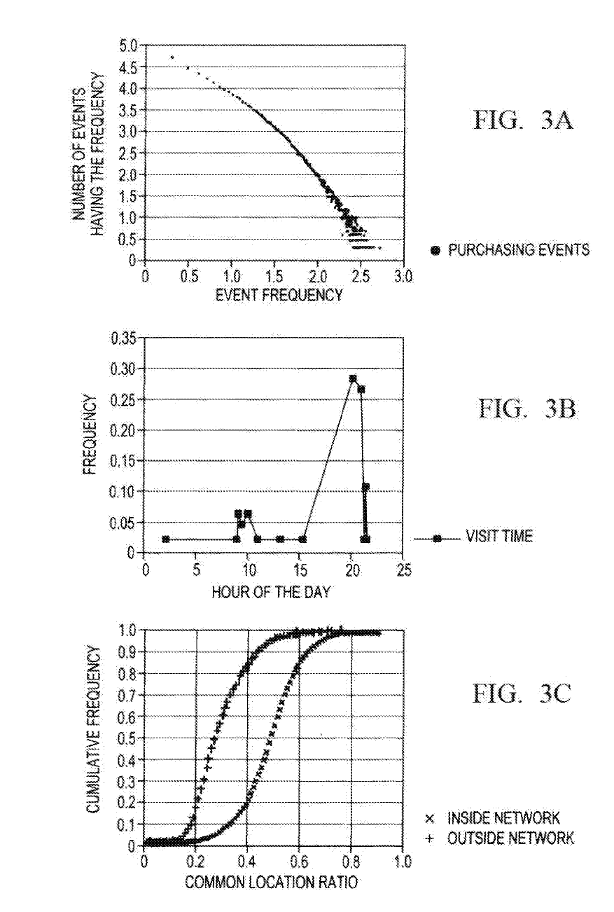

For each customer, we extract locations visited from transaction records, composing a location sequence in chronological order denoted as si=v1v2 . . . vn, where vi ∈ S. The spatial model takes si as training data to learn the probability of the next visit vn+1 taking a value from S. We assume the contextual dependencies have a limited range—that is, we only consider visited locations in the same day as context. Then si is segmented by date into a set of subsequences, denoted as Hi={ŝi=v1+kv2+k . . . vm+k| as si=v1v2 . . . vk,0 k and m+k n}. Given a daily sequence of visited locations =̂=v1v2 . . . vn−1 as context and Hi as training data, the model estimates the probability Psₚₐₜᵢₐₗ (vn=1i|ŝ,Hi) for each li ∈ Σ. In our dataset, the average length of context as defined is 2.71 with a variance of 0.64, which means the model should be able to handle a varying range of dependencies. To estimate this probability, it's important to understand the distribution of each location in the sequence, which can be interpreted as customers' purchasing preferences. FIG. 3A reports the frequency distribution of purchasing event <ui, vj>ignoring time difference in a log-log scale. The function is approximately power law, meaning that most customers visit a small range of locations frequently but many more locations occasionally. This “rich get richer” property is another feature that must be addressed in a spatial model.

Temporal Preference Distribution

Given a customer and a location, we can get a person's temporal preferences by counting the number of occurrences of timestamp tk in the dataset. Formally, the probability of tk taking value x is:

$${R}_{Temporal} ( f ( {t}_{k} ) = x \vert {u}_{i} , {l}_{j} ) = \frac{\vert \{ 〈 u , v , t 〉 \vert u = {u}_{i} , v = {l}_{j} , f ( t ) = x \} \vert}{\vert \{ 〈 u , v , t 〉 \vert u = {u}_{i} , v = {l}_{j} \} \vert} , \qquad ( 1 )$$

where f is a time format function that returns desired values from a timestamp such as hour (daily) or day of week (weekly), and x is a specific value in a corresponding format. FIG. 3B gives an example of a discrete distribution of hourly visit frequency, indicating that for this specific user, the most likely visiting time at this location is around 20:00 (8 p.m.). The shape of such a distribution can be interpreted as the time regularity of human mobility, which means people tend to visit locations at some “representative time.” P_{Temporal} in Equation 1 could be 0 if the model estimates the probability on an unobserved time value. One common smoothing strategy is to fit the discrete distribution by the Gaussian Mixture Model (GMM), which empirically defines the number of Gaussian components. However, an empirically defined number of Gaussian components might not fit future data. Additionally, when training data is sparse, the GMM's shape is vulnerable to new observations.

Implicit Social Influence

Humans can influence their friends' mobility in a social network, but this type of friendship information isn't always available in real-world datasets. For instance, in our dataset, friends can make purchases together, but we can only observe that their records have close timestamps. The actual friendship link isn't available. To exploit the influence of latent relationships between customers, we extract an implicit network from the original data. Every customer is a node in Gimplicit, and an edge is defined as a latent relationship. For every pair of distinct customer ui and uj, we compare their historical purchasing events. If they've made purchases in the same place within a predefined time interval τ time, we connect the two customers. Edge weight in this graph is the frequency that the connected customers meet the connection criteria. FIG. 3C reports a common location ratio comparison between connected and unconnected customers in this implicit network. It indicates that connected users have more common visiting locations.

Prediction Model Implementation

We first introduce our predictive model for spatial sequences, and then we describe a probabilistic model that estimates temporal cyclic behavior and uses it as a regulator for the spatial model. We then added to this combined model a booster component that considers implicit social relationships among customers.

Linguistic Model for Spatial Sequence Prediction

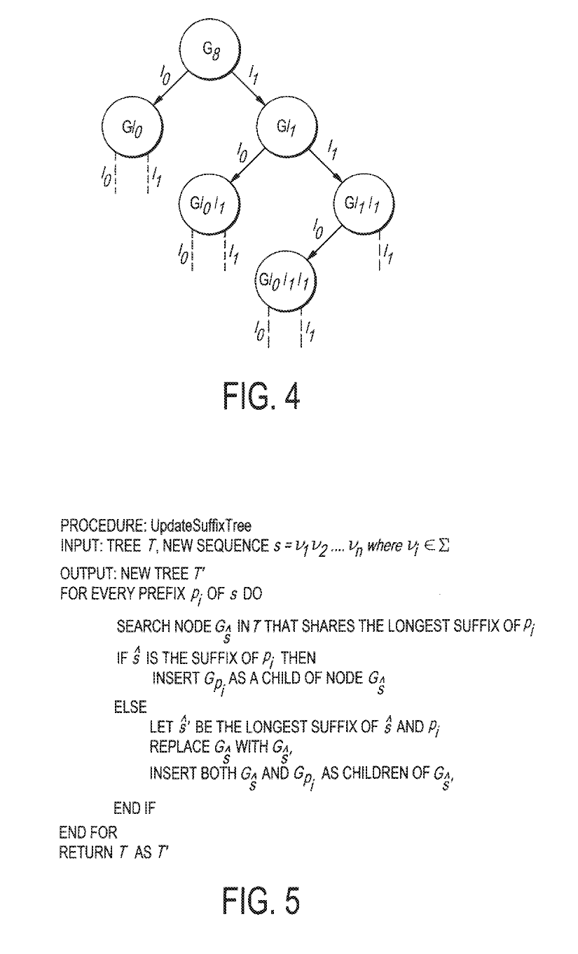

Recall that in our spatial sequence, locations exhibit a power-law distribution, which is a well-known attribute of words in natural language. It's therefore reasonable to use language processing techniques to model spatial sequences. In fact, the task of predicting the subsequent location in a spatial sequence is similar to a Web query recommendation—context in spatial sequence prediction includes visited locations in the same day, whereas context in a Web query recommendation includes words already in that query. Both tasks predict the next item that will appear after the context. Reports show that the average length of Web queries is 2.85 words, which is similar to the average length of our visiting context. We start with the probabilistic suffix tree (PST), which is commonly used for storing spatial sequences in text data. Specifically, we build a dedicated suffix tree for every individual. Each edge represents a location, and every possible prefix of a daily location sequence when reversed is represented by a path starting from its root. As FIG. 4 illustrates, the suffix tree stores a daily sequence ŝi=l₀l₁l₁l₀. Every node stores the conditional distribution Gŝ of context ŝ over location set S. Any observed contexts can be formed by appending edge labels from a specific leaf node to the root. Whenever a new daily sequence is observed, the tree will be updated according to the algorithm in FIG. 5. Given a context, the model searches the PST for the context node and makes predictions based on distribution Gŝ. If a context isn't in the PST, the model searches the tree again for the longest suffix of the context. This procedure is recursively applied until the context is found or becomes e. This strategy avoids a fixed-order Markov assumption. To infer Gŝ, we place a prior distribution over Gŝ and update it to a posterior distribution using historical data. Knowing that locations follow a power-law distribution similar to words, we use the Pitman-Yor process (PYP) as the prior distribution. PYP stochastically generates the power law distribution and has been successfully applied for smoothing the probability estimation in N-gram language models.6 Ĝ with a PYP prior is defined as Gŝ˜PYP(d,−,GO), where parameters d and q control the power-law scaling, and base distribution G0 is the expected value of Gŝ under repeated draws. So far, we've defined the suffix tree and distribution Gŝ, but we still have to combine the two. To do this, we extend PYP to a hierarchical structure. Let Gδ (ŝ) be the parent node of Gŝ, which means that δ(ŝ) is the longest suffix of ŝ; then the hierarchical PYP is defined as

$$\{ \begin{matrix}{G}_{ɛ} \sim PY ( {d}_{0} , {θ}_{0} , {G}_{0} ) \\ {G}_{\hat{s}} \sim PY ( {d}_{GI} , {θ}_{\vert \hat{s} \vert} , {G}_{δ ( \hat{s} )} ) for \hat{s} \neq ɛ\end{matrix} ,$$

where G0 is a uniform distribution over S, and d|ŝ| and θ|ŝ| are parameters that depend on the length of context ŝ. Such a hierarchy formally defines the suffix tree structure. The expected value of Gs under repeated draws from the PYP is the distribution of its parent node Gδ(s), which lets the model share information across different contexts. In particular, prediction distributions with contexts that share longer suffixes are more similar to each other and the earliest events are least important for determining the next purchase location, which is often the case. The remaining problem is to determine the range of context used for prediction. Considering the various lengths of contexts, we apply a mixture model with a variable-order Markov assumption. Let v1, v2, . . . ,vn−1 be the sequence of preceding visits observed in the same day; then the probability distribution of the spatial sequence model is derived as

$${P}_{Spatial} ( {v}_{n} = {l}_{j} \vert {u}_{i} , {v}_{1} {v}_{2} … {v}_{n - 1} ) = {\sum }_{k = 1}^{n - 1} {e}^{- β Δ t} {P}_{HBST}^{i} ( {v}_{n} = {l}_{j} \vert {v}_{k} {v}_{k + 1} … {v}_{n - 1} ) \\ for each {l}_{j} ∈ Σ , \qquad ( 2 )$$

where Δt is the time duration from the beginning events to the end events, and b controls the decaying rate. Here, e−bΔt indicates that recent context is more important; PⁱHBST is the distribution found in the suffix tree of ui.

Modeling Temporal Preference

As discussed earlier, given a customer and location, the temporal model estimates the probability distribution over time. Motivated by the fact that human mobility has a high time regularity, we assume that customers have temporal preference when they visit a location to make purchases. Instead of detecting the preferred time by counting on empirical data, we employ a GMM to smooth the distribution from Equation 1. The center of each Gaussian component represents a time preference of customer ui at location 1j. Hence, the number of components is critical for the prediction. To determine the number of components, we apply the DPGMM model, which is the GMM with a Dirichlet process prior. The parameters of each Gaussian component are drawn from G˜DP(a, G0), a discrete distribution drawn from a Dirichlet process with concentration parameter a and base distribution G0. This allows the GMM to have an unbounded number of components that best fit the training data. Another issue affecting the performance of temporal prediction is data sparseness. To solve this problem, we first create a location graph in which locations are connected based on their space and social similarities, then we discover areas through modularity clustering on the graph. Let G(V, E) be the location graph and V be the set of locations. For each li, lj ∈ V, we compute their geographic distance denoted as d(i, j), which is treated as the space similarity. Then we represent each location li as a vector Xi=[c1, c2, . . . , c|U|], where ci is the number of transactions made by ui at this location. The dimension of this vector is equal to the number of customers.

Using this representation, we can compute the cosine similarity between locations as their social similarity, denoted as

$$s ( i , j ) = \frac{{χ}_{i} \cdot {χ}_{j}}{‖ {χ}_{i} ‖ ‖ {χ}_{j} ‖} .$$

To avoid connecting two locations that are geographically far from each other, we let s(i,j)=0 if the distance between two locations exceeds the threshold τ_{distance}. After creating this graph, we apply the Louvain method to detect “communities,” a multilevel aggregation algorithm for modularity optimization. Each detected community is a group of locations that are close to each other and frequently visited by the same group of customers. Let m be the function that maps a location to an area; probability derived from temporal model is then

$${P}_{Temporal} ( f ( t ) \vert {u}_{i} , m ( {l}_{j} ) ) = {\sum }_{i = 1}^{k} {π}_{i} N ( f ( t ) \vert {μ}_{i} , {σ}_{i} ) , \qquad ( 3 )$$

where πi is mixing proportions, and μi and σi are mean and variance. Combining Equations 2 and 3, we have the probabilistic model for spatial-temporal prediction:

$${P}_{ST} ( {v}_{n} = {l}_{j} \vert {u}_{i} , {v}_{1} {v}_{2} … {v}_{n - 1} , {t}_{k} ) = {P}_{Spatial} ( {v}_{n} = {l}_{j} \vert {u}_{i} , {v}_{1} {v}_{2} … {v}_{n - 1} ) {P}_{Temporal} ( f ( {t}_{k} ) \vert {u}_{i} , m ( {l}_{j} ) ) , \qquad ( 4 )$$

which means that given a future time tk and a customer ui, the probability of ui visiting lj at tk is the probability of lj being visited by ui based on visited locations on the same day, regulated by the probability of ui appearing at the area to which lj belongs at time tk.

Modeling Implicit Social Influence

The last component is modeling social influence in our dataset. As discussed earlier, we connect customers in an implicit network if they made purchases in a same location within a time window. Considering people have different levels of sociability, for each connected customer in the implicit network Gimplicit, we define the social impact degree of ui as

$${ω}_{i} = \frac{1}{\vert N ( i ) \vert} {\sum }_{{u}_{i} ∈ N ( i )} \frac{\vert {C}_{i} ⋂ {C}_{i} \vert}{\vert {C}_{i } \vert} , where N ( i )$$

is a set of influential neighbors of ui withτneighbor neighbors obtained by ranking neighbors according to their eigenvector centrality score, and Ci records the location visited by ui. Therefore, wi measures the similarity of location preference between ui with his or her neighbors in the implicit network. To leverage social influence in our model, we first make predictions without Gimplicit, that is, by obtaining a set L(uj) containing τlocations most probable next locations for each neighbor uj ∈ N(i). Then we define the model incorporating social influence as

$${P}_{STS} ( {v}_{n} = {l}_{j} \vert {u}_{i} , {v}_{1} {v}_{2} … {v}_{n - 1} , {t}_{k} ) = {P}_{ST} ( {v}_{n} = {l}_{j} \vert {u}_{i} , {v}_{1} {v}_{2} … {v}_{n - 1} , {t}_{k} ) + {ω}_{i} {\sum }_{{u}_{p} ∈ N ( i )} \frac{{η}_{{l}_{j} , {u}_{p}}}{\vert N ( i ) \vert} , \\ where {η}_{{l}_{j} , {u}_{p}} = 1 if {l}_{j} ∈ L ( {u}_{p} ) , otherwise \\ {η}_{{l}_{j} , {u}_{p}} = 0. \qquad ( 5 )$$

Experimental Evaluation

We evaluated our proposed model's significance and performance on a real-world smartcard transaction dataset. We performed experiments to evaluate the following aspects: the performance of our proposed model for spatial sequence prediction compared with baseline models; the effectiveness of clustering and DPGMM in temporal preference prediction; the contribution of a combination of spatial and temporal components in improving accuracy; the contribution of a social influence component in improving accuracy; and the potential for applying our model as an anticipatory system, compared to a model described elsewhere.

Experimental Data

To evaluate our model, we conducted experiments using a real-world anonymized dataset collected from a large educational institution. The data was collected from smartcard transactions from June 2012 to May 2013. In our experiments, we considered customers who have at least 50 records and obtained a sample of 13,753 unique customers, 271 locations, and 3,512,018 transactions. After removing holidays (when few activities transpire), we segmented the transactions into nine stacked time chunks so that the increment between two chunks is approximately 30 days. We performed a prediction on each chunk repeatedly for every student. The prediction accuracy is defined as

$$accuracy = \frac{1}{\vert U \vert} {\sum }_{{u}_{i} ∈ U} ϕ ( P ( {u}_{i} ) , ACT ( {u}_{i} ) ) ,$$

where P(ui) is the predicted location, ACT(ui) is the actual location, and j(P(ui), ACT(ui))=1 if P(ui)=ACT(ui), otherwise j(P(ui), ACT(ui))=0.

Spatial Sequence Prediction

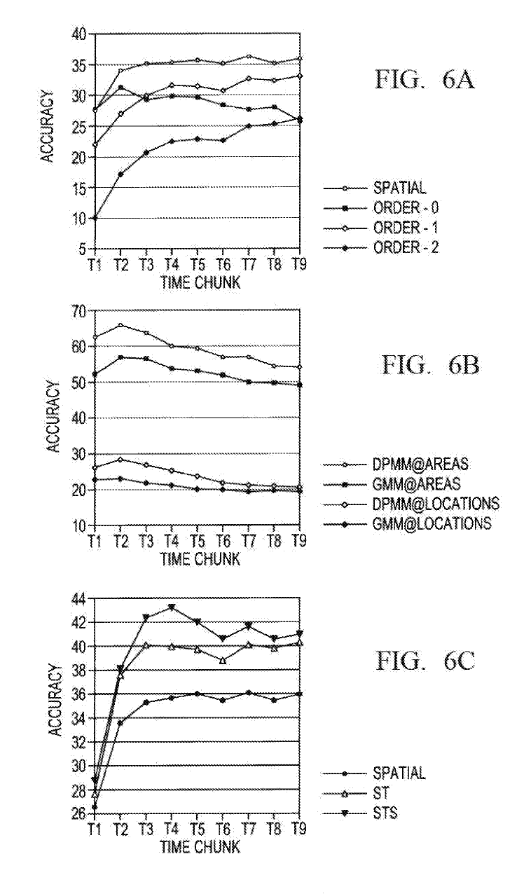

To predict spatial sequences, we compared the spatial model with three kinds of baseline Markov models of order 0, 1, and 2, respectively. The order-0 Markov model is equivalent to predicting the most frequent location; FIG. 6A shows the result. From the results, we see that our spatial sequence model has the best performance in all tests. In the first two time chunks, the order-0 Markov model outperforms the other Markov models because it predicts the most frequent location and thus captures the rich-get-richer property when the diversity of visited locations is limited. As time goes by, the order-0 Markov model shows a decreasing trend of accuracy because it overlooks context dependencies. The order-1 and order-2 Markov models have relatively low accuracy due to insufficient training data, and both show an increasing trend of accuracy when there's more training data. We also observe that the higher-order Markov model performs worse than lower-order ones on our dataset. This is because longer Markov chains suffer more from overfitting, which in turn demonstrates the importance of smoothing in modeling contextual dependencies. The previous observations also explain why our proposed model outperforms all baseline models—it can smoothly model contextual dependencies and capture the power-law distribution property.

Temporal Preference Prediction

To illustrate our temporal predictive model's effectiveness, we first show the significance of using unbounded components in GMM as well as predicting areas of locations instead of a single location. To conduct this experiment, given the timestamp of a test instance, we compare the area or location with the highest probability in PTemporal to the actual area or location. Parameter τdistance controls the number of areas we can discover. The smaller the value of τdistance, the more areas we will discover. Considering people's walking range on a university campus, we empirically set τdistance as 50 meters and obtained 78 areas from 271 locations. We compared DPGMM with the GMM used elsewhere for both location and area prediction. FIG. 6B shows that using DPGMM to predict areas results in the highest accuracy. We further demonstrate the effectiveness of adding PTemporal as a regulation over PSpatial. FIG. 6C shows that the combined model PST is 4 percent more accurate than PSpatial, hence, incorporating temporal regularities makes the subsequent location prediction more precise. Also PST is more applicable than PSpatial because it makes predictions both temporally and spatially.

Social Influence

Next, we compare the accuracy before and after adding the probabilistic component for social influence. Parameters τ neighbor and τ locations determine the extent to which the added component can affect the final prediction. A higher value of τ locations indicates that when estimating the next probable location for a user, the predictive model considers his or her neighbors' activities preferentially. Similarly, a higher value of τ locations means that the estimated next location is more likely to be found in the set of possible locations of the customer's neighbors. Empirically, the best performance is achieved when τ neighbor is 10 and τ locations is 5. FIG. 6C shows that the system gained an approximately 2 percent accuracy boost. Stable accuracy after time chunk T2 is around 41 percent.

Potential as an Anticipatory System

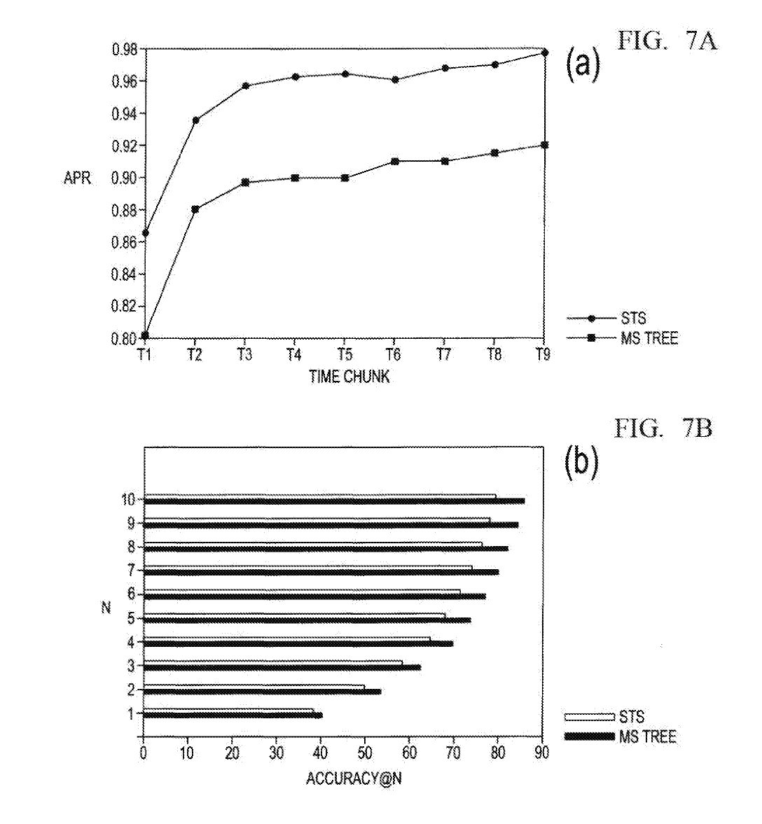

In another experiment, we compare models—ours and the M5 Tree. As previously discussed, the purpose of prediction is to identify where a person will show up in the next time period. This will enable the development of systems that proactively offer product recommendations, coupons, or assistance with information related to the place the person will visit. A successful prediction means that the (actual) next location visited by the user appears in the list of top-N predicted candidate locations and that it's ranked high. Two metrics are used for this comparison: Accuracy@N, where N indicates the size of the candidate set; and average percentile rank (APR), in which percentile rank is defined as

$$\frac{\vert Σ \vert - rank + 1}{\vert Σ \vert} ,$$

where Σ is the list of all locations, and rank is where the correct location is ranked. APR is the average percentile rank of all users. FIGS. 7A and 7B show that our model is better than the M5 Tree on both APR and Accuracy@N. This is to be expected because in our model, spatial transition patterns and temporal preferences are analyzed at a very fine-grained level. In the M5 model, spatial transitions are based only on the current location, not the full sequence of previous locations. Moreover, users' temporal preferences aren't modeled over continuous time like ours. Model is novel because it utilizes a language model for spatial sequence prediction and demonstrates that temporal preferences and implicit social influence are complementary to the spatial context in improving prediction accuracy.

Conclusion

In this disclosure, we present a new approach for student retention prediction. From smartcard transactions, we generated implicit social networks and sequences of locations, which enable the inference of students' social integration and campus integration. Experimental evaluation shows a strong performance boost by using these new features. Our work also shows class imbalance learning helps improve the performance. In particular, we proposed an extension of under-sampling, which uses clustering to maintain the distribution patterns in the subset of the majority class. In the learning phase, we compared two ensemble methods and proved that both of them are better than existing model for student retention. The limitation of this research lies in the low accuracy for the drop-out class. The current model makes Type II errors which might lead to a higher cost of interventions (trade-off to maximizing recall). Future directions to address this issue include: 1) exploring additional data on campus actives such as Wi-Fi activity logs; 2) making improvements to the different steps during the learning process, e.g., the clustering algorithm for under-sampling and the ensemble method for combining results.

1. A non-transitory computer-readable medium that stores a program for analyzing student retention rates, that when executed, causes a processor to:
receive input of a plurality of financial transaction variables associated with a plurality of students;
aggregate the plurality of financial transaction variables into a network of students, wherein a connection between students in the network represents a latent relationship;
calculate a plurality of network features based on the connections between students, wherein said network features indicate the students' integration; and
forecast retention for each of the plurality of students.

2. The non-transitory computer-readable medium of claim 1, wherein the network features are comprised of node appearance metrics, degree metrics, and edge metrics.

3. The non-transitory computer-readable medium of claim 2, wherein the node appearance metrics are further comprised of number of appearance periods and longest consecutively appearance periods.

4. The non-transitory computer-readable medium of claim 2, wherein the degree metrics are further comprised of average degree, standard deviation of degrees, and ratio of average degree between a first half of networks and a second half of networks.

5. The non-transitory computer-readable medium of claim 2, wherein the edge metrics are further comprised of a proportion of strong out-going edges, a proportion of strong in-coming edges, and a proportion of loyal edges.

6. The non-transitory computer-readable medium of claim 1, wherein the data related to a financial card transaction is comprised of a student identifier, a service type, a location indicator, and a timestamp.

7. The non-transitory computer-readable medium of claim 1, wherein the processor is further programmed to calculate a plurality of campus integration metrics using the plurality of financial transaction variables, wherein said campus integration metrics are used to forecast retention rates for each of the plurality of students.

8. A computer-implemented method for analyzing student retention rates comprising the steps of:
receiving input of a plurality of financial transaction variables associated with a plurality of students;
aggregating the plurality of financial transaction variables into a network of students, wherein a connection between students in the network represents a latent relationship;
calculating a plurality of network features based on the connections between students, wherein said network features indicate the students' integration; and
forecasting retention for each of the plurality of students.

9. The computer-implemented method of claim 8, wherein the network features are comprised of node appearance metrics, degree metrics, and edge metrics.

10. The computer-implemented method of claim 9, wherein the node appearance metrics are further comprised of number of appearance periods and longest consecutively appearance periods.

11. The computer-implemented method of claim 9, wherein the degree metrics are further comprised of average degree, standard deviation of degrees, and ratio of average degree between a first half of networks and a second half of networks.

12. The computer-implemented method of claim 9, wherein the edge metrics are further comprised of a proportion of strong out-going edges, a proportion of strong in-coming edges, and a proportion of loyal edges.

13. The computer-implemented method of claim 8, wherein the data related to a financial card transaction is comprised of a student identifier, a service type, a location indicator, and a timestamp.

14. The computer-implemented method of claim 8, further comprising the step of calculating a plurality of campus integration metrics using the plurality of financial transaction variables, wherein said campus integration metrics are used to forecast retention for each of the plurality of students.

15. A non-transitory computer-readable medium that stores a program that causes a processor to:
receive input of a plurality of financial transaction variables associated with a plurality of students;
calculate a spatial sequence model using the input, said calculation taking the form of:
$${P}_{Spatial} ( {v}_{n} = {l}_{j} \vert {u}_{i} , {v}_{1} {v}_{2} … {v}_{n - 1} ) = {\sum }_{k = 1}^{n - 1} {e}^{- β Δ t} {P}_{HBST}^{i} ( {v}_{n} = {l}_{i} \vert {v}_{k} {v}_{k + 1} … {v}_{n - 1} ) \\ for each {l}_{j} ∈ Σ , \qquad ( 2 )$$
where Δt is a time duration from the beginning events to the end events, b controls a decaying rate, and wherein v1, v2, . . . ,vn−1 is a sequence of preceding visits observed in the same day;
wherein said calculation predicts the subsequent location of a student in a spatial sequence.

16. The non-transitory computer-readable medium of claim 15, further comprising calculating a temporal sequence model, said calculation taking the form of:
$${P}_{ST} ( {v}_{n} = {l}_{j} \vert {u}_{i} , {v}_{1} {v}_{2} … {v}_{n - 1} , {t}_{k} ) = {P}_{Spatial} ( {v}_{n} = {l}_{j} \vert {u}_{i} , {v}_{1} {v}_{2} … {v}_{n - 1} ) {P}_{Temporal} ( f ( {t}_{k} ) \vert {u}_{i} , m ( {l}_{j} ) ) , \qquad ( 4 )$$
wherein said calculation predicts a student's spatial location and the time at which said student will be at said location.

17. The non-transitory computer-readable medium of claim 15, further comprising calculating a social influence model, said calculation taking the form of:
$${P}_{STS} ( {v}_{n} = {l}_{j} \vert {u}_{i} , {v}_{1} {v}_{2} … {v}_{n - 1} , {t}_{k} ) = {P}_{ST} ( {v}_{n} = {l}_{j} \vert {u}_{i} , {v}_{1} {v}_{2} … {v}_{n - 1} , {t}_{k} ) + {ω}_{i} {\sum }_{{u}_{p} ∈ N ( i )} \frac{{η}_{{l}_{i} , {u}_{p}}}{\vert N ( i ) \vert} , \\ where {η}_{{l}_{j} , {u}_{p}} = 1 if {l}_{j} ∈ L ( {u}_{p} ) , otherwise \\ {η}_{{l}_{j} , {u}_{p}} = 0. \qquad ( 5 )$$
wherein said calculation predicts the social influence of the student among his peers.

18. The non-transitory computer-readable medium of claim 17, wherein the data related to a financial card transaction is comprised of a student identifier, a service type, a location indicator, and a timestamp.

19. The non-transitory computer-readable medium of claim 17, wherein said model is used to forecast student retention at a facility of higher learning.

20. The non-transitory computer-readable medium of claim 17, wherein said model is used to create a model of implicit social networks between the plurality of students.
